(19) United States
(12) Patent Application Publication
(10) Pub. No.: US 2024/0101404 A1
(43) Pub. Date: Mar. 28, 2024

(54) ACCESSORY FOR A VEHICLE

(71) Applicant: JACK OUT, LLC, Pueblo, CO (US)

(72) Inventor: PATRICK MICHAEL HENRIKSON, PUEBLO, CO (US)

(21) Appl. No.: 18/372,763

(22) Filed: Sep. 26, 2023

(30) Foreign Application Priority Data
Sep. 28, 2022 (ZA) 2022/10703

(51) Int. Cl. B66F 13/00

(52) U.S. Cl. CPC B66F 13/00

(57) ABSTRACT

The invention relates to a vehicle accessory assembly suitable for releasably and securely receiving a track of a trail jack, the vehicle accessory assembly being connectable to a standard two-inch receiver hitch system or a ball hitch system and/or a pintle hitch system such that one or more wheels of a vehicle may be freed from an obstruction on a road or trail, the obstruction being one or more of soft sand, mud, marshy land, snow, potholes and/or sinkholes and wherein the vehicle accessory assembly allows for the lifting and movement of the vehicle in a range of directions in order to free it from the obstruction on the road or trail.

### CROSS-REFERENCE TO RELATED APPLICATION

This application is based on and claims priority to South Africa Provisional Patent Application Serial No. 2022/10703, filed on Sep. 28, 2022, which is incorporated herein by reference it its entirety.

### FIELD OF THE INVENTION

This invention relates to an accessory assembly for a vehicle.

More specifically this invention relates to an accessory assembly for a vehicle which may be used to releasably receive a track of a trail jack to move and/or lift a vehicle.

### BACKGROUND

Farm or trail jacks are commonly available and are used to lift heavy loads. The term “trail jack” shall be used in this specification.

In some instances, trail jacks are used on vehicles to lift a vehicle in order to clear it from any obstructions on the road or trail on which the vehicle is on. The trail jack is often used where the vehicle may be stuck with one or more wheels being in soft sand, mud, snow, marshy land, sinkholes, large potholes and the like.

Trail jacks are an essential tool for purposes of going out into nature with a vehicle such as a 4×4, SUV or even a sedan.

Unfortunately, the use of a trail jack requires particular attention as to how it is used and how it is fitted to a vehicle in order to prevent it from slipping free from the vehicle or malfunctioning thereby injuring the user.

It is well known that a trail jack may slip free from a vehicle when one is trying to lift the vehicle. For example, the support base of the trail jack may be on uneven or slippery ground and as the load on the jack increases, the support base may begin to slip.

It is further well known that if a vehicle is not provided with specific structural points on the chassis to receive a trail jack, the trail jack may be improperly fitted to a vehicle, resulting in the trail jack slipping free and/or damaging the vehicle or one or more parts of a vehicle, such as a door panel or a bumper.

There are various types of accessories to be used with a trail jack, for example those that hook onto a vehicle wheel itself such that the wheel may be lifted by the trail jack. Although useful, it does not provide for a great range of lateral movement of the vehicle. Similarly, using a trail jack with a winch kit provides limited options in trying to recover a vehicle that is stuck.

### OBJECT OF THE INVENTION

It is an object of the invention to provide a vehicle accessory assembly which releasably receives a track of a trail jack to move and/or lift a vehicle, wherein the vehicle may be moved and/or lifted safely and wherein the above-mentioned disadvantages are at least partially overcome.

A further object of the invention is to provide a vehicle accessory assembly which releasably receives a track of a trail jack to move and/or lift a vehicle, wherein the vehicle may be lifted and/or moved and displaced in a forward or backward direction or a left or right direction or any combination thereof.

### SUMMARY OF THE INVENTION

According to a first aspect of the present invention there is provided a vehicle accessory assembly suitable for releasably and securely receiving a track of a trail jack, the vehicle accessory assembly comprising:
(a) a mounting member, adapted and configured to be releasably mounted to a vehicle;
(b) a receiver assembly, moveable in a range of directions relative to the vehicle to which the mounting member is secured, the receiver assembly being dimensioned and configured to releasably receive and secure the track of the trail jack.

The track may be an elongate toothed track.

In an embodiment of the invention, the receiver assembly includes a channel member releasably connected to the mounting member and moveable on either side of the mounting member. The channel member lies in a first plane which is substantially perpendicular relative to a second plane in which the mounting member lies.

The channel member is able to receive a first pivot member such that the channel member is pivotally connected to the mounting member by the first pivot member, wherein the channel member is pivotable about the first pivot member and wherein the channel member is able to receive a second pivot member. The channel member is pivotable at least forty-five to ninety degrees on either side of the first pivot member.

The channel member also includes a sleeve member, dimensioned and configured to receive the track of a trail jack, the sleeve member being moveable from a nested position within the channel member and a second position wherein the sleeve member has been moved outwardly and away from the channel member. The sleeve member is able to receive a second pivot member, the sleeve member being pivotally connected to the channel member by the second pivot member, wherein the sleeve member is pivotable, about the second pivot member, between a first position, wherein the sleeve member is nested in the channel member, and a second position wherein the sleeve member has been pivoted outwardly therefrom.

The receiver assembly may be adjusted to accommodate the track of a trail jack in a range of positions depending on whether the vehicle, and one or more wheels of the vehicle, is or are to be lifted and/or moved rearwardly, forwardly, to the side or a combination of one or more of these, such that the vehicle and/or one or more wheels of the vehicle may be freed from an obstruction on a road or trail, the obstruction being one or more of soft sand, mud, marshy land, snow, potholes, sinkholes and the like.

According to a second aspect of the present invention there is provided a vehicle accessory assembly suitable for releasably and securely receiving a track of a trail jack, the vehicle accessory assembly comprising:
(a) a mounting member, adapted and configured to be releasably mounted to a vehicle, an end of the mounting member being able to receive a first pivot member;
(b) a channel member, able to receive the first pivot member and being pivotally connected to the mounting member by the first pivot member, wherein the channel member is pivotable about the first pivot member and wherein the channel member is able to receive a second pivot member;
(c) a sleeve member, able to receive the second pivot member and being pivotally connected to the channel member by the second pivot member, wherein the sleeve member is pivotable, about the second pivot member, between a first position, wherein the sleeve member is nested in the channel member, and a second position wherein the sleeve member has been pivoted outwardly therefrom, the sleeve member being dimensioned to receive the track of a trail jack; and
   wherein the channel member lies in a first plane which is substantially perpendicular relative to a second plane in which the mounting member lies.

The mounting member is adapted to be received by a mounting adapter fitted on a vehicle. Preferably, the mounting member may be adapted to be received by a standard two-inch receiver hitch system, used in America, or on a ball hitch system used in Europe, South Africa and Australia and/or a pintle hitch system commonly used on military vehicles. These hitch systems are all appropriately designed to handle the load that a trail jack would exert.

In an embodiment of the invention, the mounting member comprises a first end, adapted to be releasably connected to a mounting adapter on a vehicle. The first end of the mounting member may have complimentary securing means to the mounting adapter in order to releasably connect the two together.

In an embodiment, the first end of the mounting member includes a first hole therein dimensioned and configured to receive a securing pin. The mounting adapter on the vehicle may have a corresponding hole, such that on receiving the mounting member, the first hole lines up with the corresponding hole in the mounting adapter and the securing pin may be placed through the mounting adapter and mounting member to releasably connect the two. For purposes of using the invention with US mounting adaptors, the hole of the mounting member is on its side in that the mounting adapter on the vehicle has the corresponding hole on the side. The position of the holes may be on any of the other sides of the mounting member and adapter so long as they correspond and line up.

The mounting member further comprises a second end, the second end being provided with a second hole, to receive the first pivot member, to releasably connect it to the channel member.

In one embodiment of the invention the channel member is provided with a connecting member to releasably connect the channel member to the mounting member. The connecting member may be in the form of at least one flange extending from the channel member, the flange having a flange hole therein, which flange hole is dimensioned and configured to line up with the second hole in the second end of the mounting member. In a form of the invention, the connecting member comprises two flanges, each having a hole therein which shall line up with the second hole in the second end of the mounting member.

The first pivot member may be any suitable member that is able to be received by the second hole and flange hole or holes, if two flanges are used. In one embodiment of the invention, the first pivot member simply comprises a bolt and nut assembly, wherein the bolt fits through the second hole and the hole in the at least one flange to releasably and securely connect the mounting member to the channel member.

In a preferred form of the invention the channel member is pivotable at least forty-five (45) to ninety (90) degrees on either side of the first pivot member, preferably ninety (90) degrees. It will be appreciated that in use, the mounting member will be fixed to the vehicle such that only the channel member may be pivoted about the first pivot.

According to a third aspect of the present invention there is provided a vehicle accessory assembly suitable for releasably and securely receiving a track of a trail jack, the vehicle accessory assembly comprising:
(a) a mounting member, adapted and configured to be releasably mounted to a vehicle;
(b) a channel member, connected to the mounting member;
(c) a sleeve member pivotally connected to the channel member wherein the sleeve member is pivotable between a first position, wherein the sleeve member is nested in the channel member, and a second position wherein the sleeve member has been pivoted outwardly therefrom, the sleeve member being dimensioned to receive the track of a trail jack; and
   wherein the channel member is substantially perpendicular relative to the mounting member.

In this, the third aspect of the invention, the mounting member comprises a bracket, dimensioned and configured to receive the ball of a ball hitch system. The mounting member further comprises a securing means to secure the bracket to the ball hitch system. In an embodiment of the invention the securing means comprises a “v” or “u” shaped bolt, each end thereof being receivable within an aperture provided on each end of the bracket. Each end of the bolt may be fastened to the bracket by a fastening member, such as a bolt nut.

According to the third aspect of the invention, in which the mounting member comprises a bracket, the channel member is affixed to the bracket. In this embodiment the channel member does not pivot about the mounting member, however the same movement may be achieved by rotating the bracket about the ball of a ball hitch system. It will be appreciated that in this embodiment, the mounting member, and hence the channel member, has a greater range of movement around the ball hitch system than other embodiments herein described.

In the embodiments of the invention heretofore described, the channel member of the invention comprises a base, from which there is either a flange extending outwardly from the base, or from which the mounting member is affixed thereto, and two opposed channel walls, extending outwardly and in the opposite direction to the flange or mounting member, to form a “U” shape.

Each channel wall may include a first and a second set of diametrically opposite channel wall holes. The first set of diametrically opposed channel wall holes and the second set of diametrically opposed channel wall holes are dimensioned to receive a second pivot member while the second channel wall holes are dimensioned to receive a securing pin or a third pivot member. The first set of diametrically opposed channel wall holes are provided towards a first end of the channel member while the second set of diametrically opposed walls holes are provided towards a second end of the channel member.

The channel member is complimentarily dimensioned to receive the sleeve member such that the sleeve member is nested in the channel member and vice-versa.

The sleeve member may, in an embodiment of the invention, be a rectangular tube. At least two opposed walls of the rectangular tube are provided with a first set and a second set of holes therein which are diametrically opposed, and which are configured in the rectangular tube to line up with the first and a second set of diametrically opposite channel wall holes.

A second pivot member may be received through the first set of holes in the channel member and the corresponding set of holes in the sleeve member such that the sleeve member is pivotable about the second pivot member. The sleeve member is pivotable between a first position wherein it is nested in the channel member and a second position wherein it pivotally extends outwardly from the first end of the channel member to a maximum of ninety degrees, preferably forty-five degrees.

The second pivot member may be any suitable member that is able to be received by the first and second set of channel wall and sleeve member walls. In one embodiment of the invention, the second pivot member simply comprises a bolt and nut assembly.

The sleeve member may, in one embodiment of the invention, be secured in its first position by means of a securing pin received through the second set of channel wall holes and the corresponding set of second holes in the sleeve member.

In another embodiment of the invention, the securing pin may be replaced by a third pivot member. The third pivot member may comprise a bolt and nut assembly. The third pivot member is inserted into the second set of diametrically opposed holes provided at the second end of the channel member and the corresponding holes in the sleeve member. By removing or not inserting the second pivot member, the sleeve member is able to pivot about the third pivot member between a first position, wherein the sleeve member is nested in the channel member, and a second position wherein the sleeve member may be pivoted about the third pivot member outwardly from the second end of the channel member by ten degrees to a maximum of the sixty degrees, preferably between 20 degrees and 50 degrees, more preferably 30 degrees to 45 degrees.

The mounting, channel and sleeve members may be made from the same or different material. So too may the first and second pivot members and securing members be made out of the same or different material to each other and the mounting, channel and sleeve members.

According to a fourth aspect of the invention, there is provided a kit for a vehicle accessory assembly comprising:
(a) a mounting member, adapted and configured to be connected to a mounting adaptor of a vehicle;
(b) a channel member, connectable to the mounting member;
(c) a securing means for securing the mounting member to the mounting adapter of the vehicle; and
(d) a sleeve member pivotally connectable to the channel member wherein the sleeve member is pivotable between a first position, wherein the sleeve member is nested in the channel member, and a second position wherein the sleeve member has been pivoted outwardly therefrom, the sleeve member being dimensioned to receive the track of a trail jack.

In a further embodiment of the kit, there is provided a kit comprising:
(a) a mounting member, adapted and configured to be releasably mounted to a vehicle, an end of the mounting member being able to receive a first pivot member;
(b) a first pivot member;
(c) a channel member, able to receive the first pivot member and being pivotally connectable to the mounting member by the first pivot member, wherein the channel member is pivotable about the first pivot member and wherein the channel member is able to receive a second pivot member;
(d) a second pivot member;
(e) a sleeve member, able to receive the second pivot member and being pivotally connectable to the channel member by the second pivot member, wherein the sleeve member is pivotable, about the second pivot member, between a first position, wherein the sleeve member is nested in the channel member, and a second position wherein the sleeve member has been pivoted outwardly therefrom, the sleeve member being dimensioned to receive the track of a trail jack.

The kit may further include securing pins as hereinbefore described.

The kit may optionally include a third pivot member instead of or in addition to the securing pins for the purpose as described herein.

In yet a further alternate embodiment of the kit, where the mounting member comprises a bracket, the kit includes:
(a) a bracket, adapted and configured to be releasably mounted to a vehicle, the bracket being attached to a channel member and having an aperture in each end thereof;
(b) a “u” or “v” shaped bolt; to be received by the apertures in the bracket;
(c) securing bolt nuts to the “u” or “v” shaped bolt to secure the bracket to the ball of a ball hitch system;
(d) a channel member, wherein the channel member is able to receive a pivot member;
(e) a pivot member;
(f) a sleeve member, able to receive the pivot member and being pivotally connectable to the channel member by the pivot member, wherein the sleeve member is pivotable, about the pivot member, between a first position, wherein the sleeve member is nested in the channel member, and a second position wherein the sleeve member has been pivoted outwardly therefrom, the sleeve member being dimensioned to receive the track of a trail jack.

In terms of a fifth aspect according to the invention, there is provided a method of freeing or moving a vehicle using a vehicle accessory assembly comprising:
(a) a mounting member, adapted and configured to be releasably mounted to a mounting adapter on a vehicle;
(b) a channel member, being pivotally connected to the mounting member;
(c) a sleeve member, being pivotally connected to the channel member, wherein the sleeve member is pivotable between a first position, wherein the sleeve member is nested in the channel member, and a second position wherein the sleeve member has been pivoted outwardly therefrom, the sleeve member being dimensioned to receive the track of a trail jack; and
(d) wherein the channel member lies in a first plane which is substantially perpendicular relative to a second plane in which the mounting member lies; the method comprising the steps of:
(a) releasably connecting the vehicle accessory assembly to a mounting adapter fitted on a vehicle;
(b) securing the vehicle accessory assembly to the mounting adapter; and
(c) adjusting the vehicle accessory assembly about the mounting adapter in order to lift the vehicle and move it in a range of directions relative to the ground.

A further method of freeing or moving a vehicle using a vehicle accessory assembly comprising:
(a) a mounting member, adapted and configured to be releasably mounted to a vehicle, an end of the mounting member being able to receive a first pivot member;
(b) a first pivot member;
(c) a channel member, able to receive the first pivot member and being pivotally connected to the mounting member by the first pivot member, wherein the channel member is pivotable about the first pivot member and wherein the channel member is able to receive a second pivot member;
(d) a second pivot member;
(e) a sleeve member, able to receive the second pivot member and being pivotally connected to the channel member by the second pivot member, wherein the sleeve member is pivotable, about the second pivot member, between a first position, wherein the sleeve member is nested in the channel member, and a second position wherein the sleeve member has been pivoted outwardly therefrom, the sleeve member being dimensioned to receive the track of a trail jack; and
   wherein the channel member lies in a first plane which is substantially perpendicular relative to a second plane in which the mounting member lies;
   comprises the steps of:
(a) releasably connecting the vehicle accessory assembly to a mounting adapter fitted on a vehicle;
(b) optionally adjusting the vehicle accessory assembly by pivoting the mounting member on either side of the first pivot member in the event that a vehicle is to be lifted and moved sideways relative to the ground;
(c) optionally adjusting the sleeve member from its first position to a second position as hereinbefore described in the event that a vehicle is to be lifted and/or moved backwards relative to the ground;
(d) optionally, and in place of (c), adjusting the sleeve member from its first position to a second position as hereinbefore described with reference to a third pivot member, in the event that a vehicle is to be lifted and/or moved backwards relative to the ground;
(e) inserting a track of a trail jack in the sleeve member; and
(f) operating the trail jack to lift and/or lift and move in a forwards, backwards or sideways manner the vehicle.

In the embodiment in which the mounting member comprises a bracket, the method of freeing or moving a vehicle, using a vehicle accessory assembly comprising:
(a) a bracket, adapted and configured to be releasably mounted to a vehicle, the bracket being attached to a channel member and having an aperture on each end thereof;
(b) a “u” or “v” shaped bolt; to be received by the apertures in the bracket;
(c) securing bolt nuts for the “u” or “v” shaped bolt, to secure the bracket to the ball of a ball and hitch system;
(d) a channel member, wherein the channel member is able to receive a pivot member;
(e) a pivot member;
(f) a sleeve member, able to receive the pivot member and being pivotally connectable to the channel member by the pivot member, wherein the sleeve member is pivotable, about the pivot member, between a first position, wherein the sleeve member is nested in the channel member, and a second position wherein the sleeve member has been pivoted outwardly therefrom, the sleeve member being dimensioned to receive the track of a trail jack
   comprises the steps of :
(a) placing the bracket about the ball of a ball hitch system;
(b) connecting the bracket to the ball of the ball hitch system by placing each end of the securing bolt through apertures provided in each end of the bracket and securing the bracket by threading each end of the securing bolt with bolt nuts;
(c) adjusting the bracket, and the channel member, about the ball of the ball hitch system as required;
(d) optionally adjusting the sleeve member from its first position to a second position as hereinbefore described in the event that a vehicle is to be lifted and/or moved backwards relative to the ground;
(e) optionally, and in place of (d), adjusting the sleeve member from its first position to a second position as hereinbefore described with reference to a third pivot member, in the event that a vehicle is to be lifted and/or moved backwards relative to the ground;
(f) inserting a track of a trail jack in the sleeve member; and
(g) operating the trail jack to lift and/or lift and move in a forwards, backwards or sideways manner the vehicle.

### BRIEF DESCRIPTION OF THE DRAWINGS

FIG. 1: an exploded perspective view of the vehicle accessory assembly, in a disassembled condition, according to the invention.

FIG. 2: a perspective view of the vehicle accessory assembly according to the invention.

FIG. 3: a perspective view of the vehicle accessory assembly according to the invention wherein the sleeve member's movement, at a first end of the channel member, and the channel member's movement is shown.

FIG. 4: a perspective view of the vehicle accessory assembly according to the invention connected to a vehicle.

FIG. 5: a perspective view of the vehicle accessory assembly according to the invention in use.

FIG. 6: a perspective view of the vehicle accessory assembly according to the invention wherein the sleeve member's movement, at a second end of the channel member, is shown.

FIG. 7: an alternate embodiment of the vehicle accessory assembly including a second pivot member and a third pivot member wherein the sleeve member is secured in the channel member.

FIG. 8: the alternate embodiment of FIG. 7, wherein the channel member has received the track of a trail jack.

FIG. 9: an alternate embodiment of the vehicle accessory assembly wherein the mounting member is a bracket affixed to the channel member.

FIG. 10: the alternate embodiment of FIG. 9, wherein the mounting member, in the form of a bracket, has received the ball of a ball hitch system, the vehicle accessory being secured to the ball hitch system.

### DETAILED DESCRIPTION OF THE DRAWINGS

The vehicle accessory assembly according to the invention is designated the reference numeral (10) in the Figures.

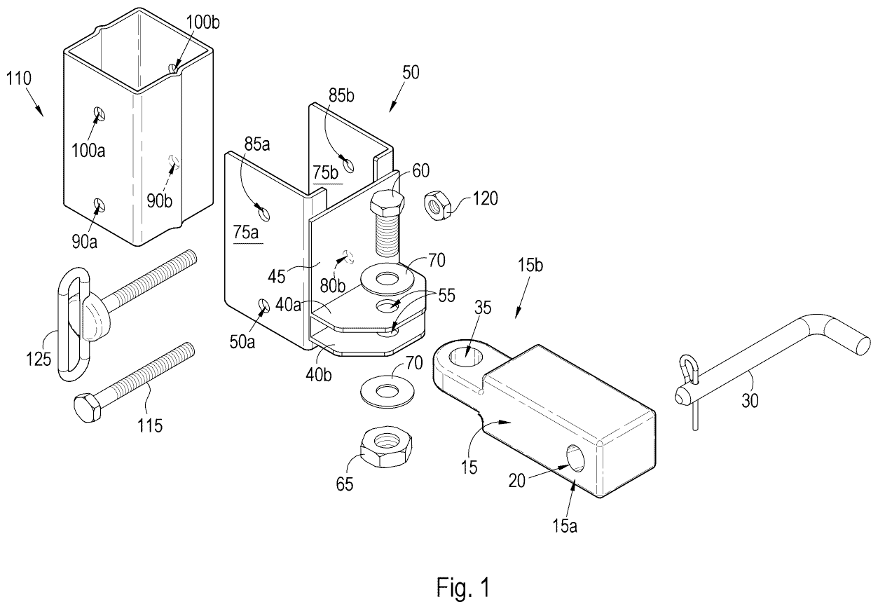

Referring to FIG. 1, the vehicle accessory assembly (10) comprises a mounting member (15) to mount the vehicle accessory assembly (10) to a mounting adaptor on a vehicle (not shown). While the mounting member (15) may be dimensioned to any appropriate size, a 2 by 2 inch dimensioned mounting member being preferred in that it will be received by North American mounting adapters.

The mounting member (15) has a first end (15a) and a first pair of opposed holes (20) for receiving a securing pin (30) in order to secure the vehicle accessory assembly (10) to a mounting adapter (not shown) on a vehicle.

A second end (15b) of mounting member (15), having a hole therein (35), is dimensioned and configured to be received by the receiver assembly which includes a connecting member comprising a pair of spaced apart flanges (40a and 40b) projecting outwardly from the base (45) of the channel member (50).

Each flange (40a and 40b) has a hole (55) therein which will correspond and line up with the hole (35) in the second end (15b) of the mounting member (15).

The mounting member (15) is releasably connected to the channel member (50) of the receiver assembly by means of a first pivot member in the form of a bolt (60) which is threaded through the first flange (40a), then the hole (35) of the mounting member (35) and then the second flange (40b), the bolt being kept in place by means of a nut (65). Washers (70) may be used.

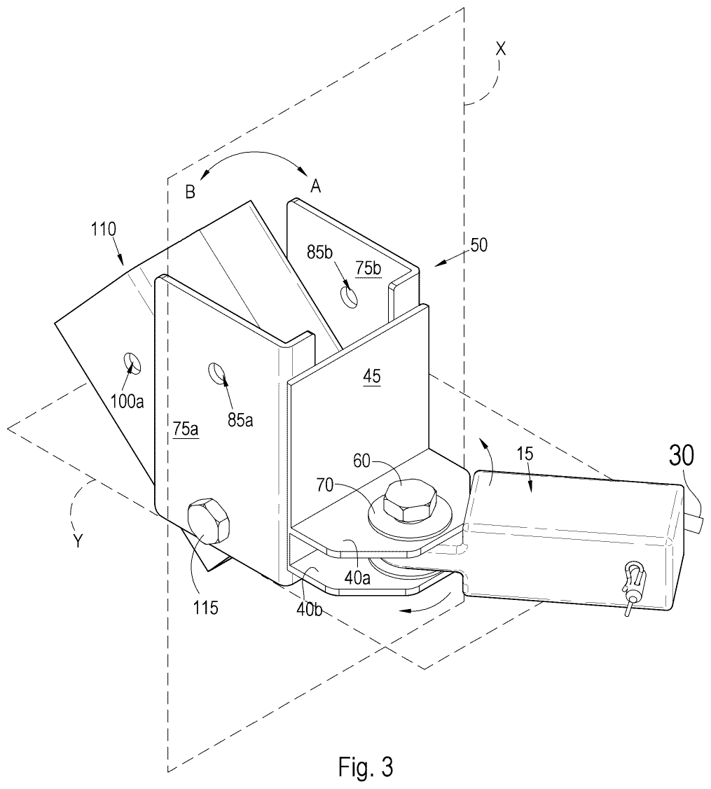

Referring to FIG. 3, it will be clear that once the mounting member (15) is releasably connected to the channel member (50), the channel member (50) is able to pivot about the bolt (60) on either side thereof as shown in the figure.

The channel member (50) comprises the base (45) from which the flanges (40a and 40b) extend and a first sidewall (75a) and a second sidewall (75b), which extend in the opposite direction to the flanges (40a and 40b), to form a “u” shaped channel.

The first sidewall (75a) and the second sidewall (75b) include a first set of diametrically opposed holes (80a and 80b) at a first end of the channel member and a second set of diametrically opposed holes (85a and 85b) at a second end of the channel member.

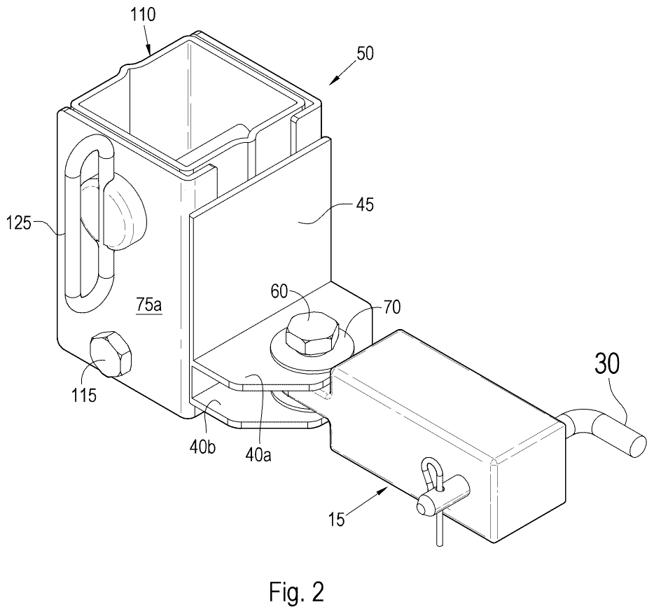

Corresponding holes (90a and 90b) and holes (100a and 100b) are provided in the sleeve member (110), which sleeve member (110) is a rectangular tube dimensioned and configured to be received in the channel member (50) so that it is nested in the channel member (50). This can be seen from FIG. 2.

A second pivot member, in the form of a bolt (115), is threaded through the first hole (80a) in the first side wall (75a) of the channel member (50), then through the first hole (90a) of the sleeve member (110) through to hole (90b) and finally through the second hole (80b) of the channel member (110), the bolt (115) being held in place by nut (120).

As demonstrated in FIG. 3, the sleeve member (110) is pivotable about the second pivot member in the form of bolt (115) between a first position “A”, wherein the sleeve member (110) is received and nested in channel member (50) and a second position “B” wherein the sleeve member (110) is pivoted outwardly from the channel member (50).

A securing pin (125) is releasably threaded through the second set of holes (100a, 75a, 100b and 75b) in the channel member (50) and the sleeve member (110) respectively so as to secure the sleeve member (110) in the channel member (50).

As will be seen from FIG. 2, the vehicle assembly accessory (10) is in its assembled from and the sleeve member (110) is releasably secured in place and nested within the channel member (50).

FIG. 3, as has been alluded to, demonstrates the movement of the channel member (50) vis-à-vis the mounting member (15), which mounting member (15) is releasably secured in place to a mounting adapter of a vehicle (not shown). FIG. 3 also shows the movement of the sleeve member (110) relative to the channel member (50). Finally FIG. 3 shows that the channel member (50) lies in a first plane “X” which is perpendicular to a second plane “Y” in which the mounting member (15) lies.

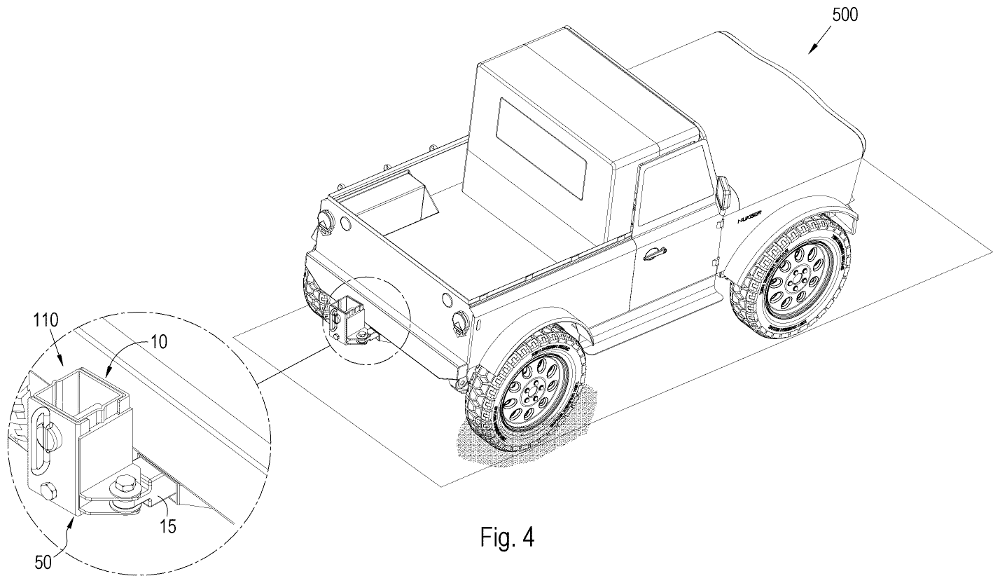

Referring to FIG. 4, the vehicle accessory assembly (10) is shown connected to a vehicle (500).

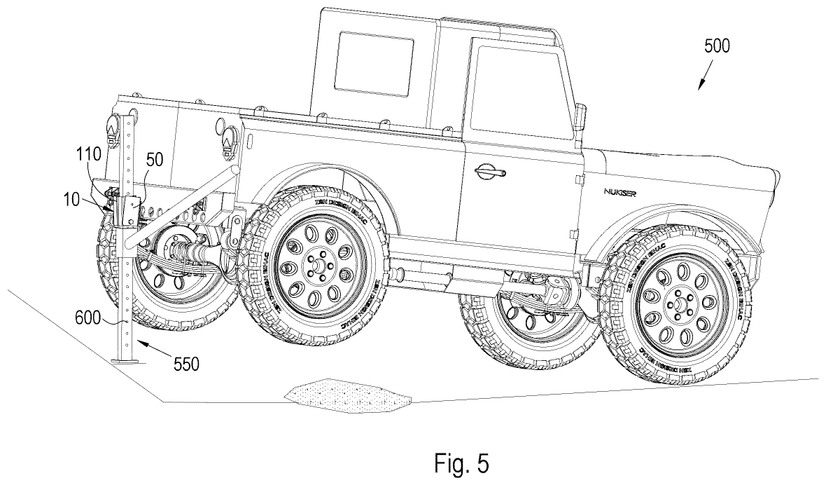

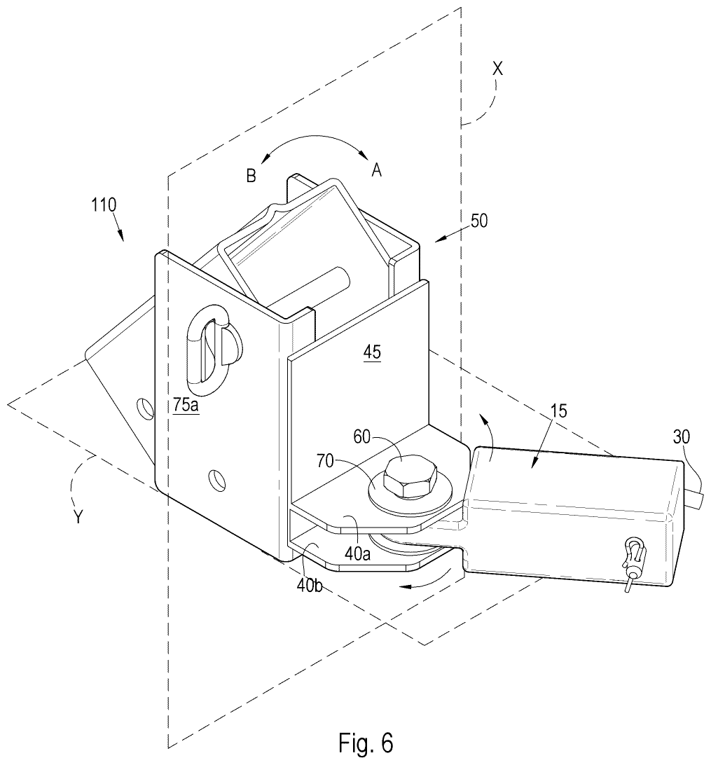

FIGS. 5 and 6 show the vehicle assembly (10) in use. By way of a non-limiting example, a vehicle (500), such as a 4×4, may, from time to time, get stuck in snow, soft sand, mud, marshy land, large potholes, and the like. In such a case, a high jack lift (550), may be used to free the vehicle (500).

FIG. 5 shows the vehicle accessory assembly (10) in use wherein the channel member (50) has been pivoted to the right of the first pivot member (60). The sleeve member (110) is shown in its second position wherein it has been pivoted outwardly from the channel member (50) and has received the track (600) such that on operating the trail jack (550) the vehicle (600), and its back right wheel (600a), is lifted and moved sideways and rearwardly away from the snow, soft sand, mud, marshy land, large potholes and the like in which the right wheel (600a) is stuck. As will be appreciated from FIG. 5, the track of the trail jack is received by the sleeve member (110) and will be kept in place such that it does not slip free.

The applicant believes that the vehicle accessory assembly (10) provides a greater freedom of movement of a vehicle being lifted by a trail jack in order to clear it of an obstruction which has caused or contributed to the vehicle being stuck.

Furthermore, the applicant believes that the use of the vehicle accessory assembly (10) will allow for a safer use of a trail jack in that the vehicle accessory assembly is releasably secured to a vehicle's mounting adapter such that the body work of the vehicle will not be damaged in use nor will the trail jack, in use, slip free from the vehicle as the trail jack's track will be retained in place by the receiver assembly, which as exemplified herein, is the sleeve member (110) of the receiver assembly.

It will be appreciated that the vehicle accessory assembly (10) may be received by a mounting adapter fitted to a vehicle on the front and/or side of the vehicle and/or the back of the vehicle.

It will further be appreciated that the channel member (50) and sleeve member (110) can be manipulated in a range of positions that will allow the vehicle and the wheel that is stuck in the snow, soft sand mud, marshy land, large pot holes and the like to be moved in a direction that is best to free the wheel and therefore the vehicle.

Furthermore, it will be appreciated that mechanical equivalents to the specific components of the vehicle accessory assembly exemplified in the detailed description may be used without departing from the spirit and scope of the invention.

For example, an alternate embodiment is illustrated in FIG. 6, wherein the sleeve member (110) is pivoted outwardly from the channel member (50) from the second end thereof, wherein the securing pin (not shown) is replaced by a third pivot member (650).

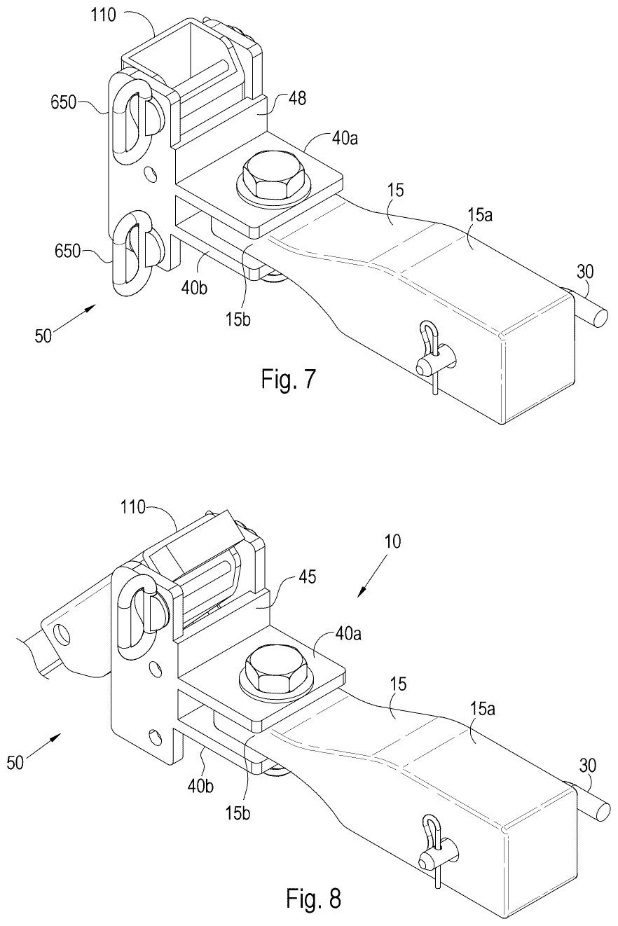

FIGS. 7 and 8 exemplify another embodiment of the invention without departing from the spirit and scope of the invention.

As can be seen in FIG. 7, the mounting member 15 has a different design to the mounting member (15) in the first embodiment described herein. This notwithstanding, the mounting member (15) still has a first end with a pair of opposed holes for receiving a securing pin (30) in order to secure the vehicle accessory assembly (10) to a mounting adapter (not shown) on a vehicle.

A second end (15b) of mounting member (15) still has a hole therein (not shown), which is dimensioned and configured to be received by the receiver assembly which includes a connecting member (50) comprising a pair of spaced apart flanges (40a and 40b) projecting outwardly from the base (45) of the channel member (50).

The channel member (50) is as hereinbefore described. So too is the sleeve member (110) which is shown, in this FIG. 7, as being secured in the channel member (50) by two securing pins. In FIG. 8 the same embodiment as in FIG. 7 is shown, wherein the bottom most securing pin (650) has been removed to allow the sleeve member (110) to move to its second position. On receiving the track (600) of trail jack in the sleeve member the vehicle (not shown) may be lifted and moved forwardly.

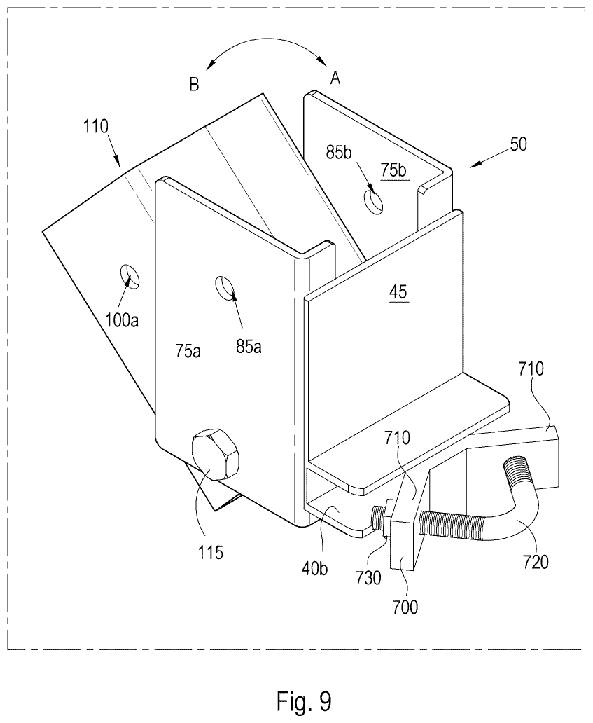

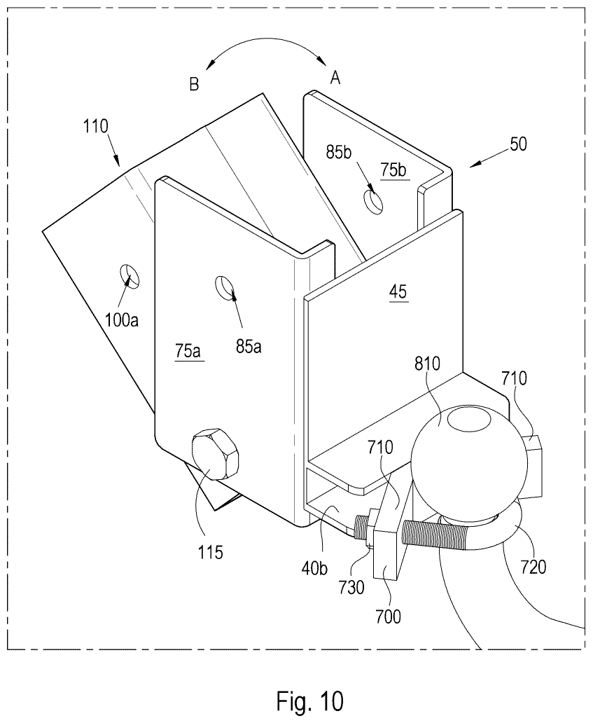

It will be appreciated that there may be other embodiments having mechanical equivalents to what is described hereinbefore without departing from the spirit and scope of the invention. For example, and referring to FIGS. 9 and 10, these show an alternate embodiment wherein the securing member is a bracket (700) secured to the channel member (50), the bracket (700) having an aperture (not shown) on each end (710) to receive each end of a “v” shaped bolt (720).

In use, the vehicle accessory member is secured to the ball (800) of a ball and hitch system (partly shown—810) by receiving the ball (800) and then being secured thereto by means of the “v” shaped bolt (720) and securing bolt nuts (730).

It will be appreciated that the mounting member retains its range of motions about the ball (800) of the ball and hitch system in a similar fashion to the mounting member pivoting about the first pivot member as herein before described.

1. A vehicle accessory assembly for releasably and securely receiving a track of a trail jack, the vehicle accessory assembly comprising:
(a) a mounting member, adapted and configured to be releasably mounted to a vehicle; and
(b) a receiver assembly, moveable in a range of directions relative to the vehicle to which the mounting member is secured, the receiver assembly being dimensioned and configured to releasably receive and secure the track of the trail jack.

2. The vehicle accessory assembly of claim 1, wherein the mounting member is adapted and configured to be received by, and releasably connected to, a mounting adapter on a vehicle.

3. The vehicle accessory assembly of claim 2, wherein the mounting adapter is selected from the group comprising a standard two-inch receiver system, a ball hitch system and a pintle hitch system.

4. The vehicle accessory assembly of claim 1, wherein the mounting member comprises a bracket, dimensioned and configured to receive the ball of a ball hitch system, and a securing means to secure the bracket to the ball hitch system.

5. The vehicle accessory assembly of claim 1, wherein the receiver assembly includes a channel member connected to the mounting member.

6. The vehicle accessory assembly of claim 5, wherein the channel member is releasably connected to the mounting member and wherein the channel member is moveable about either side of the mounting member.

7. The vehicle accessory assembly of claim 5, wherein the channel member is connected to the mounting member such that it is affixed to a bracket of the mounting member, the bracket being dimensioned and configured to receive the ball of a ball hitch system.

8. The vehicle accessory assembly of claim 7, wherein the mounting member, including the channel member, is moveable about the ball of the ball hitch system.

9. The vehicle accessory assembly of claim 5, wherein the channel member lies in a first plane which is substantially perpendicular relative to a second plane in which the mounting member lies.

10. The vehicle accessory assembly of claim 5, wherein the channel member receives a first pivot member such that the channel member is pivotally connected to the mounting member by the first pivot member, wherein the channel member is pivotable about the first pivot member and wherein the channel member receives a second pivot member.

11. The vehicle accessory assembly of claim 10, wherein the channel member is pivotable at least forty-five to ninety degrees on either side of the first pivot member.

12. The vehicle accessory assembly of claim 5, wherein the receiver assembly includes a sleeve member, dimensioned and configured to receive the track of a trail jack, the sleeve member being moveable from a nested position within the channel member and a second position wherein the sleeve member has been moved outwardly and away from the channel member.

13. The vehicle accessory assembly of claim 12, wherein the sleeve member receives a second pivot member, the sleeve member being pivotally connected to the channel member by the second pivot member, wherein the sleeve member is pivotable, about the second pivot member, between a first position, wherein the sleeve member is nested in the channel member, and a second position wherein the sleeve member has been pivoted outwardly therefrom.

14. The vehicle accessory assembly of claim 1, wherein the receiver assembly is adjustable to accommodate the track of a trail jack in a range of positions depending on whether the vehicle, and one or more wheels of the vehicle, are to be lifted, moved rearwardly, forwardly, to the side or a combination of positions.

15. The vehicle accessory of claim 14, wherein the receiver assembly is adjustable to accommodate the track of a trail jack in a range of positions in order to free one or more wheels of the vehicle from an obstruction, the obstruction being one or more of soft sand, mud, marshy land, snow, sinkholes and/or potholes.

16. A kit for a vehicle accessory assembly comprising:
(a) a mounting member, adapted and configured to be connected to a mounting adaptor of a vehicle;
(b) a channel member, connectable to the mounting member;
(c) a securing means for securing the mounting member to the mounting adapter of the vehicle;
(d) a sleeve member pivotally connectable to the channel member wherein the sleeve member is pivotable between a first position, wherein the sleeve member is nested in the channel member, and a second position wherein the sleeve member has been pivoted outwardly therefrom, the sleeve member being dimensioned to receive the track of a trail jack.

17. A method of freeing or moving a vehicle, using a vehicle accessory assembly comprising:
(a) a mounting member, adapted and configured to be releasably mounted to a mounting adapter on a vehicle;
(b) a channel member, being pivotally connected to the mounting member
(c) a sleeve member, being pivotally connected to the channel member, wherein the sleeve member is pivotable between a first position, wherein the sleeve member is nested in the channel member, and a second position wherein the sleeve member has been pivoted outwardly therefrom, the sleeve member being dimensioned to receive the track of a trail jack; and
(d) wherein the channel member lies in a first plane which is substantially perpendicular relative to a second plane in which the mounting member lies,
the method comprising the steps of:
(a) releasably connecting the vehicle accessory assembly to a mounting adapter fitted on a vehicle;
(b) securing the vehicle accessory assembly to the mounting adapter;
(c) adjusting the vehicle accessory assembly about the mounting adapter to lift the vehicle and move it in a range of directions relative to the ground.
